(19) United States
(12) Patent Application Publication
(10) Pub. No.: US 2026/0121848 A1
(43) Pub. Date: Apr. 30, 2026

(54) AVIONICS-BASED CONTROL OF AN OPEN WORLD DATA INTERFACE

(71) Applicant: Honeywell International Inc., Charlotte, NC (US)

(72) Inventors: Ravikumar Selvarajan, Madurai (IN); Sreenivasan K. Govindillam, Bengaluru (IN); Satish Mulay, Bengaluru (IN); Sri Harsha Kosuri, Bangalore (IN)

(21) Appl. No.: 19/088,602

(22) Filed: Mar. 24, 2025

(30) Foreign Application Priority Data
Oct. 29, 2024 (IN) 202411082561

(51) Int. Cl. H04L 9/08; B64D 45/00

(52) U.S. Cl. CPC H04L 9/088; B64D 45/00; B64D 2045/0075

(57) ABSTRACT

A device for controlling data communications with avionics of an aircraft is configured to receive data from a computing device via a first communications protocol during a first communication session with the computing device; in response to receiving the data, transmit a request to the avionics to initiate a second communication session with the avionics; in response to transmitting the request, receive an encryption key and an indication of a second communications protocol from the avionics; encrypt the data that was received from the computing device via the first communications protocol using the encryption key; and transmit the encrypted data to the avionics via the second communications protocol.

This application claims the benefit of IN Provisional Patent Application No. 202411082561, filed 29 Oct. 2024, the entire contents of which is incorporated herein by reference.

### TECHNICAL FIELD

This disclosure relates to systems for facilitating communication between an avionics system and an external computing device.

### BACKGROUND

The avionics industry has been making technological advancements in enabling electronic flight bag (EFB) systems to obtain complex avionics data (e.g., flight plans) from avionics data systems, such as Flight Management Systems (FMSs). The EFB systems can filter and convert complex avionics data into various streaming formats (e.g., JavaScript Object Notation (JSON) or Extensible Markup Language (XML)) and transmit the converted avionics data to various client applications in the EFB systems so that applications of the EFB may utilize the data. Applications being executed by an EFB may similarly transmit data to the FMS, providing pilots with a more user-friendly manner of interacting with the FMS.

### SUMMARY

Electronic flight bag (EFB) to flight management system (FMS) connectivity potentially presents an entry point for incorrect or corrupted data caused by a malfunction. The EFB-FMS connectivity may also present a security vulnerability that could be exploited by a nefarious actor. For example, cyber criminals could potentially utilize the connectivity channels between EFB applications and avionics to attack, or even take control of, the avionics. For instance, a cybercriminal could take control of an existing EFB application and then, posing as a legitimate EFB application, send malicious commands to the avionics using communication paths allocated for the legitimate EFB applications.

This disclosure describes techniques that secure the connectivity between an EFB and avionics by limiting an EFB's ability to directly connect or control, by for example a user datagram protocol (UDP)/socket-based connection, the avionics. As will be described in more detail below, a gateway device may be configured to control data communications between an EFB and avionics of an aircraft. The techniques of this disclosure enable avionics, like an FMS, to serve requests from EFB applications, using a gateway device as a middleman, thus preventing the EFB from establishing direct IP connections with the avionics. The communication channel and protocol are controlled by the avionics to facilitate secure transactions.

According to an example, a computer-implemented method for controlling data communication with avionics of an aircraft includes receiving data from a computing device via a first communications protocol during a first communication session with the computing device; transmitting a request to the avionics to initiate a second communication session with the avionics; in response to transmitting the request, receiving an encryption key and an indication of a second communications protocol from the avionics; encrypting the data that was received from the computing device via the first communications protocol using the encryption key; and transmitting the encrypted data to the avionics via the second communications protocol.

According to another example, a gateway device for controlling data communications with avionics of an aircraft, the gateway device comprising: a memory; and processing circuitry coupled to the memory and configured to: receive data from a computing device via a first communications protocol during a first communication session with the computing device; in response to receiving the data, transmit a request to the avionics to initiate a second communication session with the avionics; in response to transmitting the request, receive an encryption key and an indication of a second communications protocol from the avionics; encrypt the data that was received from the computing device via the first communications protocol using the encryption key; and transmit the encrypted data to the avionics via the second communications protocol.

According to another example, an avionics system mounted on an aircraft, the avionics system comprising: one or more memories; and processing circuitry coupled to the one or more memories and configured to: receive a request to establish a communication session with a computing device; generate an encryption key in response to receiving the request; determine a communications protocol for the communication session; transmit the encryption key and an indication of the communications protocol to the computing device; receive an encrypted avionics command from the computing device using the communications protocol; decrypt the encrypted version of the avionics command, using a decryption key corresponding to the encryption key, to determine a decrypted version of the avionics command; and execute the avionics command.

The details of one or more examples are set forth in the accompanying drawings and the description below. Other features, objects, and advantages will be apparent from the description, drawings, and claims.

### BRIEF DESCRIPTION OF DRAWINGS

FIG. 1 shows an overview of an example computing environment in which techniques of the present disclosure may be implemented.

FIG. 2 shows a system for implementing connectivity between an electronic flight bag (EFB) and avionics in accordance with techniques of this disclosure.

FIG. 3A is a flow diagram illustrating a data transfer process in accordance with the techniques of this disclosure.

FIG. 3B is a flow diagram illustrating a data transfer process in accordance with the techniques of this disclosure.

FIG. 4 shows an example of a gateway device for facilitating communication between an avionics system and a computing device for executing EFB applications in accordance with techniques of this disclosure.

FIG. 5 shows an example of a computing device for executing EFB applications in accordance with techniques of this disclosure.

FIG. 6 shows an example of an avionics system in accordance with techniques of this disclosure.

Throughout the figures, like reference numerals across multiple figures refer to the same hardware, software, data, step, etc.

### DETAILED DESCRIPTION

The avionics of modern aircraft often include a flight management system (FMS) that can generate a flight plan and navigate an aircraft through the flight plan. A flight plan may, for example, include a departure location, destination location, a departure time, a desired arrival time, a desired flight duration, a desired altitude, a set of waypoints, an identification of weather structures to be avoided, a fuel load for the aircraft, a number of passengers on the aircraft, a desired speed, an identification of a runway, or other such flight-related information. Based on feedback from various navigation sensors on the aircraft, the FMS may ensure that the aircraft is adhering to the flight plan. In this regard, an FMS may be viewed as the custodian of the flight plan.

An electronic flight bag (EFB) is a computing device used by pilots to review operating manuals, airport diagrams, navigational charts, and other types of reference materials that were previously paper-based. More advanced applications for interacting with an FMS and other aspects of an aircraft's avionics are being added to EFBs. With the advent of data connectivity between FMSs and EFBs, flight plans may be sent back and forth between FMSs and EFBs. For example, an FMS may generate a flight plan and supply the flight plan to an EFB for a variety of purposes such as data analytics, visualization, flight plan optimization, or the like. In other examples, an EFB may generate the flight plan and transmit the flight plan to an FMS for the FMS to execute the uploaded flight plan. This EFB-FMS connectivity brings value to the airlines and pilots in terms of situational awareness, flight efficiency, fuel efficiency, predictive maintenance, among other benefits, which can increase revenue and improve safety.

This EFB-FMS connectivity also potentially presents an entry point for incorrect or corrupted data caused by a malfunction. The EFB-FMS connectivity may also present a security vulnerability that could be exploited by a nefarious actor. For example, cyber criminals could potentially utilize the connectivity channels between EFB applications and avionics to attack, or even take control of, the avionics. For instance, a cybercriminal could take control of an existing EFB application and then, posing as a legitimate EFB application, send malicious commands to the avionics using communication paths allocated for the legitimate EFB applications.

This disclosure describes techniques that secure the connectivity between an EFB and avionics by limiting an EFB's ability to directly connect or control, by for example a user datagram protocol (UDP)/socket-based connection, the avionics. The techniques of this disclosure enable avionics to control data transfer requests from EFB applications without allowing direct IP connections. This control ensures secure transactions by utilizing a gateway that mediates communication. The avionics initiate and manage the data transfer process, enhancing security by preventing unauthorized access. As will be described in more detail below, a gateway device may be configured to control data communications between an EFB and avionics of an aircraft. The techniques of this disclosure enable avionics, like an FMS, to serve requests from EFB applications, using a gateway device as a middleman, thus preventing the EFB from establishing direct IP connections with the avionics. The communication channel and protocol are controlled by the avionics to facilitate secure transactions.

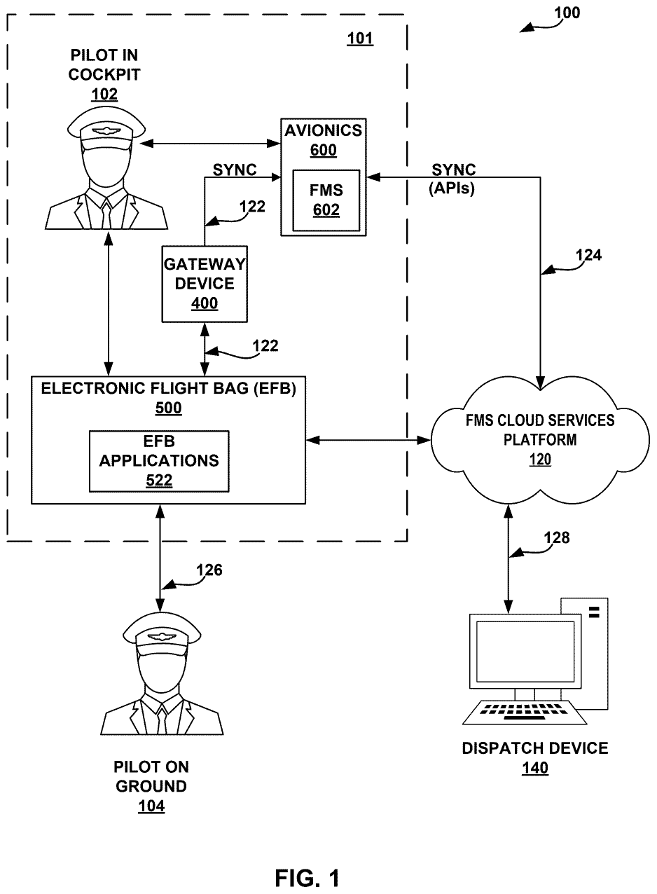

FIG. 1 shows an overview of an example computing environment 100, according to one or more examples of the present disclosure. In environment 100, gateway device 400 is configured to facilitate communication between EFB 500 and avionics 600. Gateway device 400, EFB 500, and avionics 600 are all devices or systems that may be located inside aircraft 101. Environment 100 also includes a connected FMS cloud services platform 120 (platform 120) and a dispatcher device 140, which may be located outside of aircraft 101. EFB 500 may be a computer device carried by a pilot or a flight crew, which may store, for example, navigational charts, maps for air and ground operations of an aircraft, a flight plan management system, an aircraft operating manual, flight-crew operating manual, software applications which automate flight-related or avionics-related computation tasks, and/or any application or data which may be installed in a general purpose computing platform. EFB 500 may include a pilot information display (PID).

Avionics 600 generally represents any electronic systems that may be implemented in an aircraft. Avionics 600 may, for example, perform functions related to communication, navigation, safety monitoring, and other such functionality. Avionics 600 includes FMS 602, which represents a specialized computer system with specialized software configured to automate in-flight tasks according to a flight plan. In this regard, FMS 602 may be considered to be a full or partial autopilot system. FMS 602 may, for example, perform real-time monitoring of the aircraft's position using onboard sensors (like GPS) and compare the position to the planned route defined in the flight plan. FMS 602 may also perform automatic corrections if the aircraft deviates from the planned path by adjusting the course of the aircraft to bring the aircraft back to the path defined in the flight plan.

Dispatcher device 140 may be any computer device which may be accessed by a user who performs planning, flying, navigating, or managing tasks associated with aircraft, airspaces, airports, or flight plans. Accordingly, the user is not limited to a dispatcher, and the dispatcher device 140 is not limited to a device of a dispatcher. The connected FMS cloud services platform 120 may be a cloud-based platform that provides FMS services to any user who has authorized access to the platform.

As shown in FIG. 1, the environment 100 may accommodate access by various types of users. For example, a pilot 102, who may be in cockpit, may have access to EFB 500 and EFB applications 522 installed on EFB 500. Pilot 102 may also have access to avionics 600 and FMS 602, through which pilot 102 may access the connected FMS cloud services platform 120. EFB applications 522 may access connected FMS cloud services platform 120 and provide the FMS services to the users of EFB 500 in which the EFB applications 522 are installed. In that way, EFB 500 may provide to pilot 102 user-friendly and customized user interfaces, by which pilot 102 may interact with FMS services from the platform 120.

FMS 602 may also be configured to synchronize data 124 with connected FMS cloud services platform 120, using, for example, an application programming interface (API). In addition, FMS 602 may also be configured to synchronize data 122 with EFB applications 522 via gateway device 400. Thus, in some implementations, FMS 602 may be synchronized with data from both EFB 500 and platform 120 in real-time or at predetermined intervals, in such a way that the pilot 102 may rely on the on-board FMS 602 for all tasks arising in the environment 100. The data being synchronized may, for example, be flight data, although the techniques of this disclosure are not necessarily limited to flight data.

A pilot 104, who may be on ground, may also access EFB 500 and the EFB applications 522. In some implementations, the pilot 104 and the pilot 102 in the cockpit may be the same pilot, yet under different circumstances (e.g., time and location of the access). Additionally, or alternatively, the pilot 104 may be a different pilot, or another authorized member of the flight crew, who accesses EFB 500 on the ground for an official duty related to the connected FMS cloud services platform 120. While pilot 104 is accessing the EFB applications 522 via EFB 500, the EFB applications 522 may access the connected FMS cloud services platform 120 to receive various FMS services. In that way, EFB 500 may provide user-friendly and customized user interfaces, by which FMS services 126 from the connected FMS cloud services platform 120 may be serviced to pilot 104.

A dispatcher or other user may also access the connected FMS cloud services platform 120 through a dispatcher device 140. A dispatcher, in accordance with the present disclosure, may be any authorized personnel performing duties related to dispatching of aircraft in the environment 100. For example, a dispatcher may be an airline staff, an airport staff, air traffic control personnel, a ground control personnel, a member of a relevant aviation authority, or any other authorized person who may benefit from FMS services from the connected FMS cloud services platform 120 in performing their duties. Dispatcher device 140 may be any computing device capable of establishing a connection 128 to the cloud and interfacing with the connected FMS cloud services platform 120. While the dispatcher is accessing the FMS services via the dispatcher device 140, the dispatcher device 140 may access the connected FMS cloud services platform 120 to receive various FMS services. In that way, the dispatcher device 140 may provide user-friendly and customized user interfaces, by which FMS services from the connected FMS cloud services platform 120 may be serviced to the dispatcher.

FMS 602, EFB 500, and dispatcher device 140 may include one or more devices capable of receiving, generating, storing, processing, and/or providing information associated with FMS services. For example, FMS 602, EFB 500, or the dispatcher device 140 may include a communication and/or computing device, such as a mobile phone (e.g., a smart phone, a radiotelephone, etc.), a computer (e.g., a desktop computer, a laptop computer, a tablet computer, a handheld computer), a gaming device, a wearable communication device (e.g., a smart wristwatch, a pair of smart eyeglasses, etc.), or a similar type of device.

As part of facilitating communication between any of avionics 600, EFB 500, or FMS cloud services platform 120, the systems and devices may be configured to transmit and receive flight plans in the form of a .RTE (route) file, a .FPL file (flight plan), or other file formats. As will be explained in more detail below, gateway device 400 and avionics 600 may be configured to transmit and receive .RTE and .FPL files using the encryption-based process described in this disclosure.

A .RTE file is a standard file format that may be used by FMS 602 and EFB applications 522 to store and exchange flight planning data. A .RTE file includes some or all of sections for flight information, route details, altitude and speed information, fuel information, performance data, weather information, and other notes or remarks of interest to a pilot or other user. Each section then includes a field name and a value for the field name. A non-exhaustive list of fields that may be included in a .RTE file are FLIGHT_NUMBER, AIRCRAFT_TYPE, DEPARTURE_AIRPORT, DESTINATION_AIRPORT, ESTIMATED_DEPARTURE_TIME, ESTIMATED_ARRIVAL_TIME, WAYPOINTS, AIRWAYS, DEPARTURE_PROCEDURE, ARRIVAL_PROCEDURE, CRUISING_ALTITUDE, CLIMB_PROFILE, DESCENT_PROFILE, TOTAL_FUEL, TRIP_FUEL, RESERVE_FUEL, TAKEOFF_WEIGHT, LANDING_WEIGHT, ZERO_FUEL_WEIGHT, DEPARTURE_WEATHER, ARRIVAL_WEATHER, ENROUTE_WEATHER, PILOT_REMARKS, OPERATIONAL_NOTES.

Pilots (e.g., pilots 102 and 104) and dispatcher (e.g., a user of dispatch device 140) may may use .RTE files to plan and file flight routes and ensure compliance with air traffic control and safety regulations. A .RTE file may be uploaded from EFB 500 to FMS 602 to provide necessary flight details for navigation and management during the flight. The interoperability of RTE files may facilitate sharing of flight plans between different systems and stakeholders (e.g., airlines, airports, air traffic control). Instead of or in addition to .RTE files, FMS 602 and EFB applications 522 may exchange .FPL files, which include similar information as .RTE files and are used for similar purposes as .RTE files, but have a different formatting.

As indicated above, FIG. 1 is provided merely as an example. Other examples are possible and may differ from what was described with regard to FIG. 1. The number and arrangement of devices and networks shown in FIG. 1 are provided as an example. In practice, there may be additional devices, fewer devices and/or networks, different devices, and/or networks, or differently arranged devices and/or networks than those shown in FIG. 1. Furthermore, two or more devices shown in FIG. 1 (e.g., EFB 500 and dispatcher device 140) may be implemented within a single device, or a single device shown in FIG. 1 (e.g., EFB 500, FMS 602, or dispatcher device 140) may be implemented as multiple, distributed devices. Additionally, or alternatively, a set of devices (e.g., one or more devices) of environment 100 may perform one or more functions described as being performed by another set of devices of environment 100.

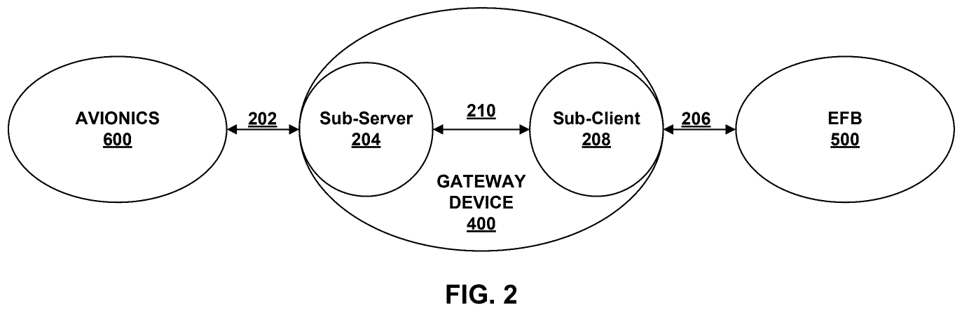

FIG. 2 shows an example of avionics-EFB connectivity via gateway device 400 in accordance with techniques of this disclosure. In the example of FIG. 2, gateway device 400 manages data communication between EFB 500 and avionics 600. In the example of FIG. 2, gateway device 400 is configured to ensure that EFB 500 and avionics 600 do not directly communicate but still have seamless communication. Gateway device 400 is configured to achieve this functionality by maintaining two separate two-way connections, one with EFB 500 and the other with avionics 600. For example, gateway device 400 may establish connection 202 with avionics 600 over the standard buses and transfer protocols available for avionics connections, such as the Aeronautical Radio, Incorporated (ARINC) 429 standard, also referred to as A429, avionics full-duplex switched ethernet (AFDX), also referred to as ARINC 664, sockets-based user datagram protocol (UDP), transmission control protocol (TCP), or file transfer protocol (FTP).

Using these standard protocols, gateway device 400 may establish a server-client protocol with avionics 600, with gateway device 400 having a sub-server role, shown in FIG. 2 as sub-server 204, and avionics 600 having an end-client role. Generally speaking, a server refers to a device or system that provides resources, services, or data, and a client refers to a device that requests services, resources, or data from the server. Typically, a client sends a request to a server, and the server processes the request and sends back a response. References in this disclosure to clients and servers are merely explanatory as to the role a device may be playing in certain scenarios and should not be interpreted to mean that a device only functions as a server or only functions as a client.

Gateway device 400 may send open and close connection requests and maintain connection 202 open via sending periodic keep-alive messages. These messages may be sent via JSON, XML, or appropriate streaming formats adhering to a pre-published schema. Sub-server 204 may, for example, send an open connection request to avionics 600 to establish connection 202 and, upon receiving a response from avionics 600, sub-server 204 may establish connection 202 and transmit data over connection 202. After completing data transfer, sub-server 204 may also send a close connection request to terminate connection 202. Sub-server 204 may also periodically send keep-alive messages to prevent connection 202 from closing due to inactivity and, thus, avoid the overhead of having to send unnecessary open connection requests.

In the context of this disclosure, an open communication session or open communication channel generally refers to an active connection between gateway device 400 and EFB 500 or between gateway device 400 and avionics 600, on which data may be exchanged in real-time. In contrast, a closed communication session or closed communication channel generally refers to a connection that has been terminated, i.e., is no longer active, such that gateway device 400 and EFB 500 or gateway device 400 and avionics 600 may no longer transmit data to one another. For example, if EFB 500 were to attempt to transmit data to gateway device 400 on a closed communication channel, then the data would not be delivered to gateway device 400.

Using A429 sub-server 204 may send data commands to avionics 600 over connection 202. Using A429, the commands may include label-based data that includes data words with a label that identifies the type of information being sent, allowing avionics 600 to interpret the data correctly. The words may, for example, be in a 32-bit word format that includes a label, data field, sign, and parity bit.

Using ARINC 664, sub-server 204 may transmit ethernet frames to avionics 600. Each ethernet frame may include a destination medium access control (MAC) address to identify a recipient device, a source MAC address to identify the sender device, an ethertype to indicate the protocol being used (e.g., AFDX), payload that contains the actual data being transmitted, and frame checking sequence for error detection. The data may be encapsulated in protocol data units, which can include multiple types of information such as a message type that Identifies the type of data (e.g., status updates, commands) and payload that identifies the actual content being communicated, which can vary based on the application. In some examples AFDX frames may include A429 data. Using AFDX, sub-server 204 may establish multiple logical data streams, each with its own bandwidth allocation and timing requirements, facilitating the transmission of different data types over a single physical network.

Although connection 202 is shown in FIG. 2 as a single connection, in some implementations, connection 202 may actually be a plurality of connections between sub-server 204 and avionics 600, via a bus, for example. Connection 202 may be physically implemented using wiring, such as twisted pair wiring. Sub-client 208 and EFB may communication over connection 206 utilizing encryption that is separate from any encryption used for connection 202. That is, sub-client 208 and EFB 500 may communicate over connection 206 using a different encryption scheme and/or a different encryption key than what sub-server 204 utilizes to communicate with avionics 600. Moreover, the encryption scheme and key utilized for connection 202 may be unknown to EFB 500.

In the example of FIG. 2, gateway device 400 may establish a connection 206 with EFB 500 using standard open world protocols such as hypertext transfer protocol (HTTP), hypertext transfer protocol secure (HTTPS), file transfer protocol (FTP), or another similar protocol. In some examples, gateway device 400 may establish connection 206 over A429 or AFDX. Over connection 206, gateway device 400 again establishes a server-client protocol but in this instance gateway device 400 acts as a sub-client, shown in FIG. 2 as sub-client 208, while EFB 500 acts as an end-server. Connection 206 may be a wireless connection over Wi-Fi or Bluetooth or may be a wired connection via a universal serial bus (USB) or serial connection. Similar to connection 202 described above, gateway device 400 and EFB 500 may exchange open and close connection requests and maintain connection 206 open via sending periodic keep-alive messages.

Once avionics-gateway connection 202 and gateway-EFB connection 206 are established, EFB 500 may connect with avionics 600 via gateway device 400 and establish a server-client protocol with avionics 600. Whenever an application of EFB 500 attempts to provide or obtain a service from avionics 600, EFB 500 may first send an API, based on JSON or XML, for example, to gateway device 400 via a first communications protocol, such as HTTP or HTTPS. The API may serve as a software interface between EFB 500 and gateway device 400.

Gateway device 400 may be configured to employ certain safety or security checks, such as device authentication, verification of data arrival rates, schema used for sending data, etc., and once satisfied, send the command to the appropriate instance of avionics 600 via a standard avionics bus protocol (e.g., A429, AFDX, etc.) over an existing connection. In some examples, gateway device 400 may present the data to the crew for the crew to review, so that the crew may accept or reject the data before the data is transmitted to avionics 600. In other examples, gateway device 400 may transmit the encrypted data automatically to avionics 600 based on an operational scenario or based on a type of request. For example, gateway device 400 may determine that a request to retrieve data from avionics 600 is valid in response to the request originating from a known source. If, however, the source for the request is unknown to gateway device 400, then gateway device 400 may require manual approval of the request. In some examples, certain types of requests, such as uploading a new flight plan or modifying an existing flight plan, may always require manual approval.

For requests that are determined to require manual approval, gateway device 400 may, for example, notify the crew about the data readiness, so that the crew can open the channel by supplying a user input. In a typical use case, a pilot may have EFB 500 in the cockpit of an airplane, and thus be in close proximity to avionics 600. The pilot may use EFB 500 to upload a new flight plan or update an existing flight plan. In response to initiating a data transfer to avionics 600 by the pilot using EFB 500, gateway device 400 may receive the data and present to the pilot via a display of avionics 600 or another display, a notification that someone is attempting to transfer data to avionics 600. The notification may, for example, include a request for the pilot to approve of deny the transfer and may include other information such as a preview of the type of data being transferred or an indication of the source (e.g., EFB 500). If the pilot initiated the data transfer on EFB 500, then the pilot can accept the data request from gateway device 400. If the pilot did not initiate the data request, then the pilot can deny the data request.

To send a command to avionics 600, gateway device 400 may, for example, signal to avionics 600 that gateway device 400 has data of a certain type that has been verified, either manually by a pilot or automatically by gateway device 400, as ready to transfer. Avionics 600 sends a unique authentication key to gateway device 400. Avionics 600 may, for example, generate the key based on the type of data. The key indicates the activation of a gateway, e.g., an avionics channel, and indicates a protocol type for the channel. That is, the specific protocol type between gateway device 400 and avionics 600 may be indicated by the activation key that avionics 600 sends to gateway device 400. Gateway device 400 receives the key from avionics 600 and encrypts the data provided by EFB 500 using the key.

As part of facilitating communication between EFB 500 and avionics 600, gateway device 400 may be configured to perform protocol conversion, or protocol translation, to convert data from the communications protocol of connection 206 to the communications protocol of connection 202. Gateway device 400 may, for example, extract data from a first communications protocol and map fields of the first communications protocol to corresponding fields in the second communications protocol to construct a command or request formatted according to the second communications protocol and then perform a similar, or reciprocal process, for any data received according to the second communications protocol.

By having avionics 600 specify a protocol translation and trigger the data transfer, secure data transfer from EFB 500 to avionics 600 may be achieved. The transfer schemes from gateway device 400 to avionics 600 may be configurable. The protocol between gateway device 400 and avionics 600 may be activated for the data transfer and may be the same or different than the protocol used between EFB 500 and gateway device 400. For example, for a bulk data request from EFB 500, avionics 600 may establish an FTP connection between gateway device 400, while the gateway device 400 and EFB 500 use HTTP. The use of dissimilar protocols reduces the common mode failures and cyber-attack scenarios. The dynamic protocol selection for data transfer and validation at different points by breaking the protocol increases cyber resilience.

Avionics 600, on the reception of this command from gateway device 400, may be configured to check the validity of the command and once satisfied, build an appropriate service response and send the response to gateway device 400 via the first protocol (e.g., the standard avionics bus protocol). Gateway device 400 may then relay this response to EFB 500 via the second protocol (e.g., HTTP or HTTPs). EFB 500 may receive this response and perform an appropriate business logic driven action.

In some examples, gateway device 400 may be configured to terminate the connection with EFB 500 and perform appropriate safety and security checks before initiating a communication session with avionics 600. This may ensure that an application of EFB 500 never takes direct control over avionics 600, which could be possible if a direct UDP/TCP connection was allowed between EFB 500 and avionics 600. To close connection 206, sub-client 208 may, for example, send an HTTP request that includes the header “Connection: close,” to indicate that connection 206 should be closed. EFB 500 may send a response indicating that the connection has been closed. The close request and response may, for example, invoke a TCP termination process.

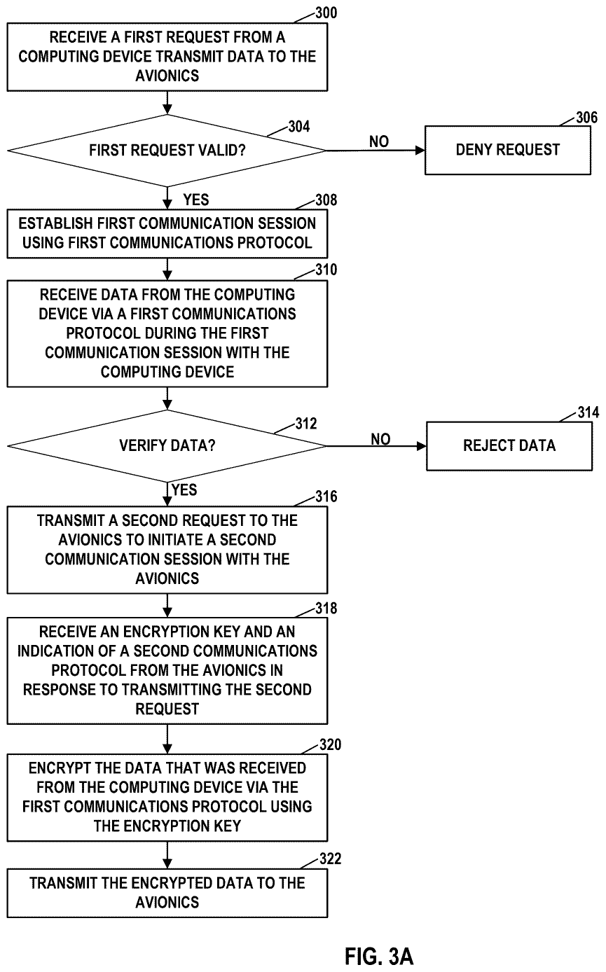

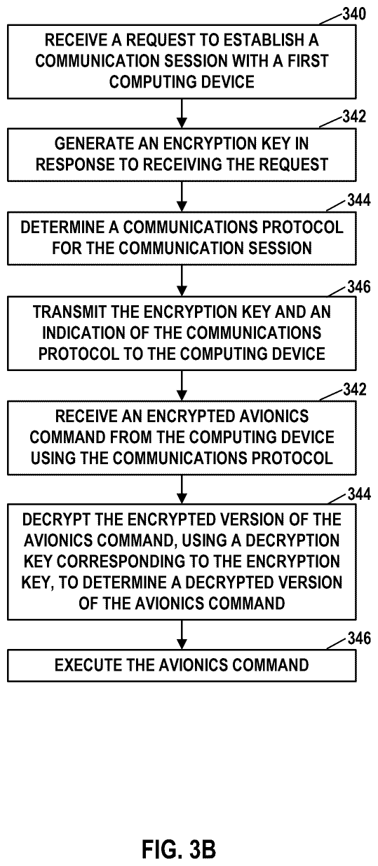

FIG. 3A is a flow diagram illustrating a data transfer process in accordance with the techniques of this disclosure. The example of FIG. 3A will be described from the perspective of gateway device 400; however, it is contemplated that other devices may also perform the process of FIG. 3A.

Gateway device 400 receives a first request from a computing device, such as EFB 500, to transmit data to avionics 600 (300). The first request may, for example, be in the form of a JSON-based API or an XML-based API for establishing a first communication session.

Gateway device 400 may determine if the first request is valid (302). If the first request is determined to be not valid (304, no), then gateway device 400 may deny the request (306). Gateway device 400 may, for example, determine the first request to be invalid if the first request does not adhere to the proper schema or if rates of arrival for data is deemed to be different than expected. Gateway device 400 may, for example, present to a pilot an indication that EFB 500 is attempting to establish a communication session with avionics 600 and approve of reject the request based on user input from the pilot. In some examples, gateway device 400 may automatically approve or automatically deny the first request based on criteria such as whether or not the computing device is a known device or based on an aircraft status, such as whether the aircraft is at the gate, taxiing, taking off, in flight, or landing. For example, gateway device 400 may be configured to deny all requests during takeoff and landing, but approve requests while in flight or parked at the gate. As part of denying the request, gateway device 400 may, for example, not establish the first communication session or may terminate the first communication session.

If gateway device 400 determines that the first request is valid (304, yes), then gateway device 400 establishes a first communication session with the computing device using a first protocol (308). The first communications protocol may, for example, be HTTP, HTTPS, or any of the other communications protocols described herein.

Gateway device 400 receives data from the computing device via the first communications protocol during the first communication session with the computing device (310). The data may, for example, be a command to upload a new flight plan or to modify an existing plan. The data may also be a request to obtain information, such as flight plan information, weather data, notices to flight crew members, GPS positioning information, airspace information, aircraft performance metrics, fuel consumption data, and the like, from avionics 600.

Gateway device 400 verifies the data (312). Gateway device 400 may, for example, present to a pilot an indication of the command or request included in the data and approve or reject the data based on user input from the pilot. In some examples, gateway device 400 may automatically approve or automatically deny the data based on criteria such as whether or not the computing device is a known device or based on an aircraft status, such as whether the aircraft is at the gate, taxiing, taking off, in flight, or landing. For example, gateway device 400 may be configured to deny commands to modify a flight plan during takeoff and landing, but approve requests while in flight or parked at the gate. In other examples, gateway device 400 may be configured to automatically approve requests for certain types of information, such as flight plan information or performance metric information, if the computing device is a known, or recognized, device.

If gateway device 400 does not verify the data (312, no), then gateway device 400 may reject, and not perform, the command or request included in the data (314). If gateway device 400 verifies the data (312, yes), then gateway device 400 may transmit a second request to avionics 600 to initiate a second communication session with the avionics 600 (316). Gateway device 400 receives an encryption key and an indication of a second communications protocol from avionics 600 in response to transmitting the second request (318). Receiving the encryption key and the indication of the second communications protocol may serve as confirmation to gateway device 400 that avionics 600 is allowing gateway device 400 to establish the second communication session. The second communications protocol may, for example, be A429, AFDX, or some other such protocol.

In some examples, gateway device 400 may be configured to terminate the first communication session with the computing device before establishing the second communication sessions with avionics 600. Gateway device 400 may, for example, transmit an end connection request to the computing device to terminate the first communication session prior to transmitting the second request to initiate the second communication session with avionics 600. By terminating the first communication session prior to establishing the second communication session, gateway device 400 may prevent the computing device from having a direct connection to avionics 600 by not having, for example, an HTTP connection with the computing device and an A429 or AFDX connection open simultaneously. Moreover, by having gateway device 400 determine if the first request is valid and verify the data before transmitting the data to avionics 600, the techniques of this disclosure may prevent errors or malicious commands from being transmitted to avionics 600.

Gateway device 400 encrypts the data that was received from the computing device via the first communications protocol using the encryption key (320) and transmits the encrypted data to avionics 600 via the second communications protocol (322). Prior to encrypting the data, gateway device 400 may also translate the data from the first communications protocol to the second communications protocol.

It should be recognized that the steps of FIG. 3A may be performed in a variety of different orders and that in some implementations certain steps may be omitted or combined. For example, in some implementations, gateway device 400 may receive the data from the computing device via the first communications protocol during the first communication session with the computing device (312) and verify the data (314) after transmitting the second request to avionics 600 to initiate a second communication session with the avionics 600 (308) and receiving the encryption key and the indication of a second communications protocol from avionics 600 in response to transmitting the second request (310). Also in some implementations, one or both of determining if the first request is valid (304) and verifying the data (314) may be omitted. In other implementations, determining if the first request is valid (304) and verifying the data (314) may essentially be combined into a single step. For example, a pilot may approve or deny both the request and the data via a single user input.

FIG. 3B is a flow diagram illustrating a data transfer process in accordance with the techniques of this disclosure. The example of FIG. 3B will be described from the perspective of avionics 600; however, it is contemplated that other devices may also perform the process of FIG. 3B.

In the example of FIG. 3B, avionics 600 receives a request to establish a communication session with a first computing device (340). In the example of FIG. 3B, the first computing device may, for example, be gateway device 400. Avionics 600 may perform additional verification of the command or request beyond what gateway device 400 did. For example, avionics 600 may perform parametric verification to the context. As one example, avionics 600 may confirm that an altitude does not exceed a maximum certified altitude.

Avionics 600 generates an encryption key in response to receiving the request (342). Avionics 600 may, for example, generate different types of encryption keys based on a category for the request, such as depending on if the request relates to route data, atmospheric data, weight data etc. Avionics 600 may generate a value based on any random text or numbers and use that value as a seed value for a cryptographic algorithm that generates encryption keys. Avionics 600 may use any algorithm or technique and any inputs to generate the seed value as long as the algorithms and inputs produces random or pseudo random values, thus resulting in some randomness or pseudo randomness in the encryption keys used.

Avionics 600 also determines a communications protocol for the communication session (344). The key may indicate the transfer scheme, e.g., FTP, IP, HTTP, etc. In some examples, the request may include information such as an amount of data to be transferred or a type of data to be transferred, and avionics 600 may determine the communications protocol based on the amount of data or type of data. For example, in response to receiving a request to transmit a large amount of data, avionics 600 may select FTP for the communications protocol, whereas for smaller amounts of data avionics 600 may select a different protocol. In some examples, avionics 600 may select the communications protocol with some degree of randomness to prevent external devices from knowing which communications protocol is to be used for any given data transfer.

Avionics 600 transmits the encryption key and an indication of the communications protocol to the computing device (346). The transmission of the encryption key and the indication of the communications protocol serves as confirmation to the computing device from avionics 600 that avionics 600 is enabling the communication session. By having avionics 600 transmit the encryption key and the indication of the communications protocol, the communication channel and protocol are controlled by avionics 600 as opposed to the first or second computing device, which provides security for the channel, by preventing the second computing device from establishing a direct IP connection with avionics 600. Requiring the first computing device to receive an encryption key and an indication of a communications protocol prior to a command being received by avionics 600, prevents EFB 500 from pushing a command to avionics 600 without the integrity and validity of the command first being verified.

Avionics 600 receives an encrypted avionics command from the computing device using the communications protocol (348). Avionics 600 decrypts the encrypted version of the avionics command, using a decryption key corresponding to the encryption key, to determine a decrypted version of the avionics command (350).

Avionics 600 executes the avionics command (352). The avionics command may, for example, be a command to upload a new flight plan or modify an existing flight plan being managed by FMS 602. The avionics command may, for example, have originated from a second computing device, such as EFB 500. Avionics 600 may also transmit a response to the second computing device via the first computing device. The response may, for example, be a confirmation that a command has been executed or may include data requested by the second computing device.

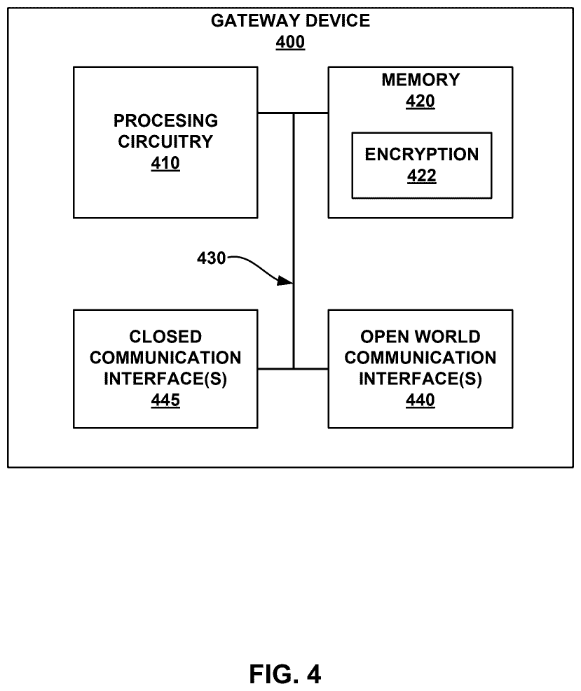

FIG. 4 illustrates an example of gateway device 400. Although this disclosure presents gateway device 400 as being separate from avionics 600, in many implementations gateway device 400 may be a component of avionics 600 or otherwise highly integrated with avionics 600. Gateway device 400 may, for example, be a subsystem of avionics 600 that is configured to transmit and receive data from open world sources over internet-based or other open world communications protocols, whereas other subsystems of avionics 600 are restricted from, or otherwise not capable of, communicating with open world sources. In this regard, gateway device 400 generally represents a boundary between proprietary functions of the avionics and computing systems external to avionics 600.

Gateway device 400 generally performs the encryption techniques described herein. In the example of FIG. 4, gateway device 400 includes processing circuitry 410, memory 420 which stores encryption application 422, open world communication interface(s) 440, closed world communication interface(s) 445. The aforementioned components of gateway device 400 may be connected to one another through a bus 430, which generally represents one or more busses and is intended to generically represent all the electrical and data connectivity of internal components included within gateway device 400.

Processing circuitry 410 implements the functionality of and/or executes the instructions associated with encryption application 422. Encryption application 422 may, for example, implement a symmetric encryptions scheme, such as the Advanced Encryption Standard, the Data Encryption Standard, the International Data Encryption Algorithm, or a Rivest Cipher scheme. Alternatively, encryption application 422 may implement an asymmetric encryption scheme, such as Rivest-Shamir-Adleman encryption, Diffie-Hellman, Elliptic Curve Cryptography, or Digital Signature Algorithm. Generally speaking, the techniques of this disclosure are agnostic with respect to the specific type of encryption used. Encryption application 422 may, for example, encrypt data, such as an avionics command, received from EFB 500 using an encryption key received from avionics 600.

Processing circuitry 410 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware, or any combinations thereof. When the techniques are implemented partially in software, gateway device 400 may store instructions for the software in a suitable, non-transitory computer-readable medium (e.g., memory 420) and execute the instructions in hardware using processing circuitry 410 to perform the techniques of this disclosure.

Memory 420 is intended to generically represent all memory included within EFB 500. In some implementations, memory 420 may include a plurality of separate devices and memory units. Theses memory devices and memory units may include volatile memory, such as random access memory (RAM), and/or non-volatile memory, such as ROM and storage media. Example of RAM include dynamic random access memory (DRAM), including synchronous DRAM (SDRAM), magnetoresistive RAM (MRAM), resistive RAM (RRAM). Examples of storage media include solid-state storage media (e.g., solid state drives and/or removable flash memory), optical storage media (e.g., optical discs), and/or magnetic storage media (e.g., hard disk drives). The aforementioned encryption application (shown in FIG. 4 as encryption 422) may be stored in any volatile and/or non-volatile memory component of memory 420.

Gateway device 400 also includes open world communication interface(s) 440 for communicating with EFB 500 and closed communication interface(s) 445 for communicating with avionics 600. In this context, open world communication interface(s) 440 generally represents any hardware for communicating via open world protocols. Open world protocols are generally considered to be protocols that are publicly available and usually standardized. Examples of open world protocols include a transmission control protocol/internet protocol (TCP/IP), a hypertext transfer protocol/secure (HTTP/HTTPS), a file transfer protocol (FTP), a secure FTP, a web socket, a constrained application protocol (CoAP), Bluetooth, ZigBee, a network file system (NFS), or the like.

Closed communication interface(s) 445 generally represents any hardware for communicating via closed protocols. In this context, a closed protocol generally refers to a protocol that is proprietary or vendor specific and for which the specifications are not publicly disclosed. A closed protocol is typically intended to limit access to specific vendors or products rather than to grant public access. Closed communication interface(s) 445 may, for example, include a secured bus for communicating directly with avionics 600.

According to techniques of this disclosure, gateway device 400 may be configured to receive data from a computing device via a first communications protocol during a first communication session with the computing device. Gateway device 400 may, for example, receive the data via open world communication interface(s) 440. Processing circuitry 410 may cause closed communication interface(s) 445 to transmit a request to avionics 600 to initiate a second communication session with avionics 600. In response to transmitting the request, processing circuitry 410 may receive via closed communication interface(s) an encryption key and an indication of a second communications protocol from the avionics. Processing circuitry 410, executing encryption application 422, may encrypt the data that was received from the computing device via the first communications protocol using the encryption key and transmit the encrypted data to avionics 600 via the second communications protocol. Gateway device 400 may, for example, transmit the encrypted data to avionics 600 via closed communication interface(s) 445.

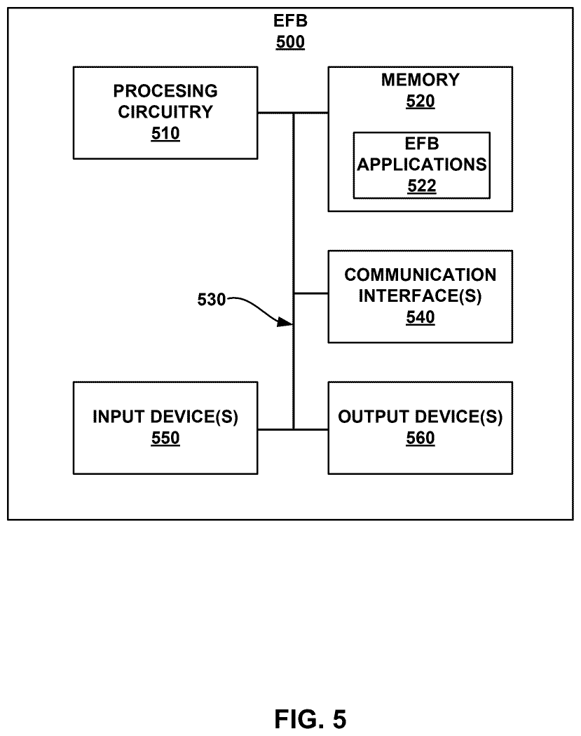

FIG. 5 illustrates an example of EFB 500. EFB 500 may be any sort of generic computing hardware, such as a tablet computer, phone, laptop computer, desktop computer, or other such computing device that is configured to store and execute EFB applications. EFB 500 may, for example, be a commercially available iOS® device or Android® device executing specialized electronic flight bag software. In other examples, EFB 500 may be specialized computing hardware configured to store and execute EFB applications. Some EFBs may be portable and be able to be carried from plane to plane, while other EFBs may be permanently mounted in a specific airplane. In the example of FIG. 5, EFB 500 includes processing circuitry 510, memory 520 which stores EFB applications 522, and communication interface(s) 540 to communicate with other devices, such as gateway device 400.

Processing circuitry 510 implements the functionality of and/or executes the instructions associated with EFB applications 522. Processing circuitry 510 may be implemented as any of a variety of suitable circuitry that includes a processing system, such as one or more integrated circuits, microprocessors, DSPs, ASICs, FPGAs, discrete logic, software, hardware, firmware, or any combinations thereof. When the techniques are implemented partially in software, EFB 500 may store instructions for the software in a suitable, non-transitory computer-readable medium (e.g., memory 520) and execute the instructions in hardware using processing circuitry 510 to perform the techniques of this disclosure.

Memory 520 is intended to generically represent all memory included within EFB 500. In some implementations, memory 520 may include a plurality of separate devices and memory units. Theses memory devices and memory units may include volatile memory, such as RAM), and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned EFB application (shown in FIG. 5 as EFB applications 522) may be stored in any volatile and/or non-volatile memory component of memory 520.

EFB 500 also includes input device(s) 550 (e.g., a keyboard, mouse, or touchscreen) and output device(s) 560 (e.g., a display, printer). In implementations where EFB 500 is a phone or tablet computer, then the EFB may, for example, have a touchscreen and a display. In implementations where EFB 500 is a larger computer device, then the EFB may, for example, have a mouse, trackpad, keyboard, or other such input devices. The aforementioned components of EFB 500 may be connected to one another through a bus 530, which generally represents one or more busses and is intended to generically represent all the electrical and data connectivity of internal components included within EFB 500.

Communication interface(s) 540 generally represents all hardware, e.g., transceiver circuitry, within EFB 500 for communicating with external devices. Communication interface(s) 540 may facilitate communication with external devices via one or more wired and/or wireless network connections by transmitting and/or receiving signals on the one or more networks. Examples of communication interface(s) 540 include a network interface card (e.g., such as an Ethernet card), an optical transceiver, a radio frequency transceiver, a GPS receiver, or any other type of device that can send and/or receive information. Other examples of communication interface(s) 540 may include short wave radios, cellular data radios, wireless network radios, as well as USB controllers.

EFB applications 522 represent a suite of software tools that may be used by a pilot in managing flight operations. EFB applications 522 may include flight planning applications that allow pilots to create and file flight plans, access weather information, and calculate fuel requirements. EFB applications 522 may also include navigation applications that provide real-time navigation support with maps, airspace information, and waypoint management. EFB applications 522 may also include weather applications that provide real-time weather data, future weather predictions, radar imagery, and the like. EFB applications 522 may also include checklist applications for ensuring compliance with pre-flight, mid-flight, and post-flight procedures. EFB applications 522 may also include various performance analysis tools that, for example, help pilots compute takeoff and landing distances based on current conditions and aircraft configuration. EFB applications 522 may also include aircraft maintenance tracking tools that track aircraft maintenance schedules, inspection records, and compliance records. EFB applications 522 may may also include flight logbooks that enable pilots to log flights, track hours, and generate reports for currency and certification. EFB applications 522 may also include airport information applications that provide information about airports, including runway layouts, services, and notices.

Examples of applications that may be included in EFB applications 522 are Honeywell GoDirect Flight Services®, Honeywell GoDirect Cockpit®, Honeywell Flight Bag®, Honeywell JetWave®, and Honeywell Smart View®.

The various example applications listed above represent a non-exhaustive list of the types of applications that may be included in EFB applications 522. As explained above, some applications of EFB applications 522 may facilitate communication with avionics 600 using the data communication techniques of this disclosure.

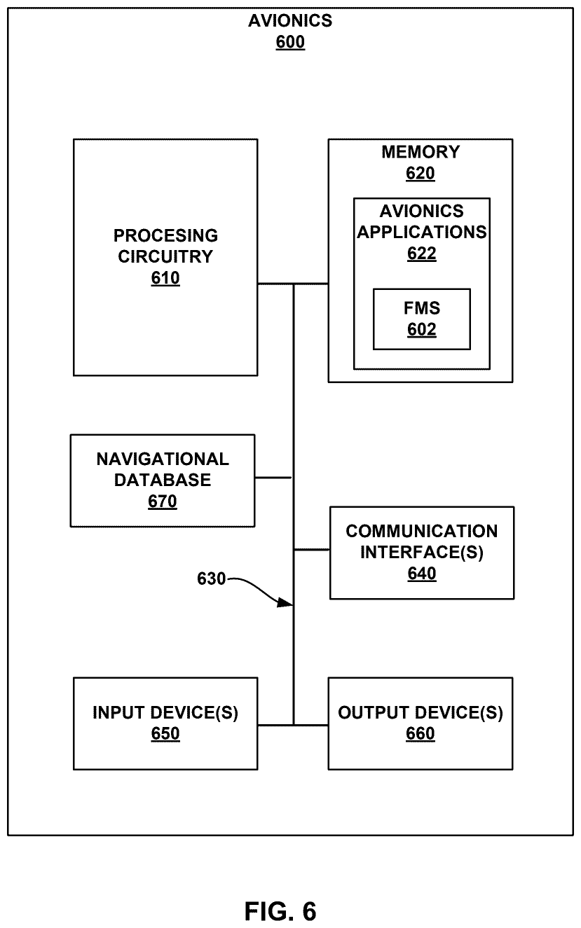

FIG. 6 illustrates an example of avionic 600. Avionics 600 is specialized computing hardware configured to store and execute avionics applications. In the example of FIG. 6, avionics 600 includes processing circuitry 610, memory 620 which stores avionics applications 622, communication interface(s) 640 to communicate with other devices, such as gateway device 400, input device(s) 650, output device(s) 660, and navigational database 670. The aforementioned components of avionics 600 may be connected to one another through a bus 630, which generally represents one or more busses and is intended to generically represent all the electrical and data connectivity of internal components included within avionics 600.

Processing circuitry 610 implements the functionality of and/or executes the instructions associated with avionics applications 622. Processing circuitry 610 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware, or any combinations thereof. When the techniques are implemented partially in software, avionics 600 may store instructions for the software in a suitable, non-transitory computer-readable medium (e.g., memory 620) and execute the instructions in hardware using processing circuitry 610 to perform the techniques of this disclosure.

Memory 620 is intended to generically represent all memory included within avionics 600. In some implementations, memory 620 may include a plurality of separate devices and memory units. Theses memory devices and memory units may include volatile memory, such as RAM, and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned avionics application (shown in FIG. 6 as avionics applications 622) may be stored in any volatile and/or non-volatile memory component of memory 620.

Communication interface(s) 640 generally represents all hardware e.g., transceiver circuitry, within avionics 600 for communicating with external devices either on the ground or while in flight. Communication interface(s) 640 may facilitate communication with external devices via one or more wired and/or wireless network connections by transmitting and/or receiving signals on the one or more networks. Examples of communication interface(s) 640 include a network interface card (e.g., such as an Ethernet card), an optical transceiver, a radio frequency transceiver, a GPS receiver, or any other type of device that can send and/or receive information. Other examples of communication interface(s) 640 may include short wave radios, cellular data radios, wireless network radios, as well as USB controllers. Examples of communication interface(s) 640 for in-flight communication include a very high frequency (VHF) radio, a high frequency (HF) radio, or a satellite communication (SATCOM) radio.

Examples of communication interface(s) 640 used for data links include an aircraft communications addressing and reporting system (ACARS) for providing a digital data link system that allows for the exchange of messages between the aircraft and ground stations for purposes such as flight plan updates, weather information, and maintenance reports. Another examples of communication interface(s) 640 used for data links include controller-pilot data link communications (CPDLC) which allows air traffic control to send instructions and receive acknowledgments from pilots via text messages. Communications interface(s) 640 may also include an automatic dependent surveillance-broadcast transponder. The various examples of communications interfaces listed above represent a non-exhaustive list of the types of the types of communication interfaces that may be included in communication interface(s) 640.

Avionics 600 also includes input device(s) 650 and output device(s) 660. Examples of input device(s) 650 include control display units (CDUs) with alphanumeric keypads or touchscreens to enter flight plans, waypoints, and other necessary data. Input device(s) 650 may also include an FMS control panel for entering information to the FMS, such as route, altitude, and speed using dedicated buttons, knobs, and touchscreen interfaces. Input device(s) 650 may also include yoke or sidestick controls as well as touchscreen interfaces. Input device(s) 650 may also include rotary knobs for setting values for altitudes, speeds, and other parameters and toggle switches for selecting modes or turning systems on and off.

Examples of output device(s) 660 may include an electronic flight instrument display to provide visual representations of flight data, including altitude, airspeed, heading, and attitude. Output device(s) 660 may also include a Heads-Up Display (HUD) that projects critical flight information onto a transparent screen in the pilot's line of sight or other cockpit displays to show navigation maps, engine parameters, system statuses, and the like. Output device(s) 660 may also include engine instrumentation displays to display data on engine performance, such as temperature, pressure, and revolutions per minute (RPMs). Output device(s) 660 may also include audio panels to relay communication from radios and alerts from systems to the cockpit. Output device(s) 660 may also include an FMS display to show flight plan information and performance data, as well as a traffic collision avoidance system (TCAS) display to alert pilots to nearby aircraft and potential collision threats.

The various examples of input and output devices listed above represent a non-exhaustive list of the types of the types of input and output devices that may be included in input device(s) 650 and output device(s) 660. Additionally, input and output functionality of avionics 600 may facilitated by external devices that are separate from input device(s) 650 and output device(s) 660. For example, EFB 500 may be configured to input data to and output data for avionics 600.

Avionics applications 622 represent a suite of software tools that may be used by a pilot in managing flight operations and managing the aircraft while in flight. Avionics applications 622 includes FMS 602 discussed above as well as other applications for communication, navigation, and monitoring within an aircraft. Avionics applications 622, for example, include applications for processing and displaying weather radar data and presenting essential flight information such as altitude, airspeed, attitude, and heading to a pilot. Avionics applications 622 also include various safety applications related to surveillance systems (e.g., transponders to communicate the aircraft's identity and altitude to air traffic control and other aircraft, such as automatic dependent surveillance-broadcast (ADS-B) systems that provide real-time data to air traffic control and other aircraft). Avionics applications 622 may also include the software to manage various emergency systems (e.g., an emergency locator transmitter, flight data recorder, and cockpit voice recorder) and cabin management systems (e.g., passenger infotainment systems and environmental control systems).

Navigational database 670 represents a specialized database that stores information needed by FMS 602 for the navigation and operation of an aircraft for purposes such as flight planning, route management, and ensuring safe navigation throughout a flight. Navigational database 670 may, for example, store waypoints, airways, navigational aids, airport information, standard instrument departures (SIDs) and standard terminal arrival routes (STARs), route data, and flight plans. The waypoints represent information on predefined geographical locations used for navigation, including both en-route waypoints and arrival/departure waypoints. The airways are data defining structured flight paths in the sky, including various air routes and connecting points. The navigational aids may, for example, be information on radio beacons, such as VHF Omnidirectional Range and Instrument Landing Systems that assist pilots in navigation. The airport information may, for example, include details about airports, including runway configurations, elevation, communications frequencies, and available approaches. SIDs and STARs may provide standardized paths for departures and arrivals. The route data may, for example, include information on preferred routes, including distance and estimated times. The flight data may be data regarding planned routes, altitudes, and waypoints for a specific flight. The locations of waypoints, airports, and navigational aids may, for example, be defined by geographical coordinates.

Navigational database 670 may also store information related to restrictions and procedures, performance data, and weather information. The restrictions and procedures may include airspace restrictions, no-fly zones, and specific procedures that need to be followed during flight. The performance data may include information related to aircraft performance, including altitude constraints, and speed limits. The weather information may include relevant meteorological data that might affect flight paths, such as wind patterns or turbulence zones. Navigational database 670 may be regularly updated to reflect changes in air traffic regulations, airport information, and navigational aids to ensure pilots have current information for safe and efficient flight operations.

Although not explicitly shown in FIG. 6, avionics 600 may include or be in communication with numerous other hardware components or hardware systems, such as a global positioning system (GPS) receiver, an inertial navigation system (INS) that includes gyroscopes and accelerometers to calculate position based on movement, weather radar for detecting weather patterns, engine monitoring systems, aircraft data recording systems, flight data recording systems, and other such systems. In some examples, avionics 600 may be configured to utilize inputs from a variety of specialized sensors such as altitude sensors, airspeed sensors, attitude sensors, heading sensors, GPS sensors, temperature sensors, pressure sensors, fuel sensors, weight and balance sensors, navigation sensors, environmental sensors, collision avoidance sensors, and other such sensors.

Avionics 600 may be configured to securely receive data uploads from EFB 500 via gateway device 400. Processing circuitry 610 may receive, via communication interface(s) 640, a request to establish a communication session with gateway device 400. Processing circuitry 610 may generate an encryption key in response to receiving the request and determine a communications protocol for the communication session. Processing circuitry 610 may cause communication interfaces 640 to transmit the encryption key and an indication of the communications protocol to gateway device 400. Processing circuitry 610 may receive an encrypted avionics command from the computing device using the communications protocol and decrypt the encrypted version of the avionics command, using a decryption key corresponding to the encryption key, to determine a decrypted version of the avionics command. Processing circuitry 610 executes the decrypted avionics command by, for example, modifying a flight plan being managed by FMS 602.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communications protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A computer-implemented method for controlling data communication with avionics of an aircraft, the method comprising:
receiving data from a computing device via a first communications protocol during a first communication session with the computing device;
transmitting a request to the avionics to initiate a second communication session with the avionics;
in response to transmitting the request, receiving an encryption key and an indication of a second communications protocol from the avionics;
encrypting the data that was received from the computing device via the first communications protocol using the encryption key; and
transmitting the encrypted data to the avionics via the second communications protocol.

2. The method of claim 1, further comprising:
outputting a notification to a user in response to receiving the data;
receiving a user input from the user in response to outputting the notification; and
transmitting the request to the avionics to initiate the communication session with the avionics in response to receiving the user input.

3. The method of claim 1, further comprising:
terminating the first communication session with the computing device prior to initiating the second communication session with the avionics.

4. The method of claim 1, wherein the data comprises a flight plan to be executed by a flight management system of the avionics.

5. The method of claim 1, wherein the first communications protocol comprises one of a hypertext transfer protocol (HTTP) or a hypertext transfer protocol secure (HTTPS).

6. The method of claim 1, wherein the second communications protocol comprises one of Aeronautical Radio, Incorporated (ARINC) 429 or avionics full-duplex switched ethernet (AFDX).

7. The method of claim 1, further comprising:
receiving an application programming interface (API) from the computing device to establish the first communication session, wherein the API comprises one of a JavaScript Object Notation (JSON)-based API or an extensible Markup Language (XML)-based API; and
transmitting the request to the avionics to initiate the second communication session with the avionics in response to receiving the API.

8. A gateway device for controlling data communications with avionics of an aircraft, the gateway device comprising:
a memory; and
processing circuitry coupled to the memory and configured to:
receive data from a computing device via a first communications protocol during a first communication session with the computing device;
in response to receiving the data, transmit a request to the avionics to initiate a second communication session with the avionics;
in response to transmitting the request, receive an encryption key and an indication of a second communications protocol from the avionics;
encrypt the data that was received from the computing device via the first communications protocol using the encryption key; and
transmit the encrypted data to the avionics via the second communications protocol.

9. The gateway device of claim 8, wherein the processing circuitry is further configured to:
output a notification to a user in response to receiving the data;
receive a user input from the user in response to outputting the notification; and
transmit the request to the avionics to initiate the communication session with the avionics in response to receiving the user input.

10. The gateway device of claim 8, wherein the processing circuitry is further configured to:
terminate the first communication session with the computing device prior to initiating the second communication session with the avionics.

11. The gateway device of claim 8, wherein the data comprises a flight plan to be executed by a flight management system of the avionics.

12. The gateway device of claim 8, wherein the first communications protocol comprises one of a hypertext transfer protocol (HTTP) or a hypertext transfer protocol secure (HTTPS).

13. The gateway device of claim 8, wherein the second communications protocol comprises one of Aeronautical Radio, Incorporated (ARINC) 429 or avionics full-duplex switched ethernet (AFDX).

14. The gateway device of claim 8, further comprising:
receiving an application programming interface (API) from the computing device to establish the first communication session, wherein the API comprises one of a JavaScript Object Notation (JSON)-based API or an extensible Markup Language (XML)-based API.

15. The gateway device of claim 8, wherein the avionics comprises the gateway device.

16. An avionics system configured to be mounted on an aircraft, the avionics system comprising:
one or more memories; and
processing circuitry coupled to the one or more memories and configured to:
receive a request to establish a communication session with a computing device;
generate an encryption key in response to receiving the request;
determine a communications protocol for the communication session;
transmit the encryption key and an indication of the communications protocol to the computing device;
receive an encrypted version of an avionics command from the computing device using the communications protocol;
decrypt the encrypted version of the avionics command, using a decryption key corresponding to the encryption key, to determine a decrypted version of the avionics command; and
execute the avionics command.

17. The avionics system of claim 16, wherein the computing device comprises a first computing device and the processing circuitry is further configured to:
receive the avionics command from a second computing device via the first computing device.

18. The avionics system of claim 16, wherein the computing device comprises a first computing device and the processing circuitry is further configured to:
transmit a response to a second computing device via the first computing device.

19. The avionics system of claim 16, wherein the communications protocol comprises one of Aeronautical Radio, Incorporated (ARINC) 429 or avionics full-duplex switched ethernet (AFDX).

20. The avionics system of claim 16, wherein the computing device comprises a subsystem of the avionics system.
